(19) United States
(12) Patent Application Publication
(10) Pub. No.: US 2013/0193611 A1
(43) Pub. Date: Aug. 1, 2013

(54) Composite Polymeric Flowforming with X-Y Translating Mold Base

(71) Applicant: Dale E. Polk, JR., Titusville, FL (US)

(72) Inventor: Dale E. Polk, JR., Titusville, FL (US)

(73) Assignee: Composite Polymeric Flowforming with X-Y Translating Mold Base, Rockledge, FL (US)

(21) Appl. No.: 13/877,042

(22) PCT Filed: Oct. 1, 2011
(86) PCT No.: PCT/US11/01692

§ 371 Date: Mar. 29, 2013

Related U.S. Application Data
(60) Provisional application No. 61/404,435, filed on Oct. 1, 2010.

(51) Int. Cl. B29C 39/10

(52) U.S. Cl. CPC B29C 39/10
USPC 264/259; 425/145; 264/241

(57) ABSTRACT

A system for forming an article from composite polymeric material reinforced with fibers and other additives utilizing an extrusion system to heat and deliver the molten composite polymeric material onto a lower mold body riding on an x-y controlled structure. The combination of the x-y control of a lower mold and a volumetrically controlled extrusion device allow a “near net shape” deposition of molten composite material into the cavities of the lower mold, which is then moved over a conveyance system to a press containing the upper mold half which is used to compress and form the composite material into a final part under moderate pressures.

### FIELD OF THE INVENTION

The present invention relates to a polymeric molding process and apparatus and especially to a composite polymeric process and apparatus that utilizes a dual trolley mold transport system to vary the thickness of the extruded material, which material is molded as it is passed from the extrusion die.

### BACKGROUND OF THE INVENTION

There are a wide variety of molding systems to produce parts of thermoplastic or thermoset resins, or thermoplastic or thermoset composites. In vacuum molding, a slab (constant thickness sheet) of heated polymeric material is placed on the vacuum mold and a vacuum drawn between the mold and the heated plastic material to draw the plastic material onto the mold. Similarly, in compression molding, a lump or slab of preheated material is pressed between two molding forms that compress the material into a desired part or shape.

Compression Molding

Compression molding is by far the most widespread method currently used for commercially manufacturing structural thermoplastic composite components. Typically, compression molding utilizes a glass mat thermoplastic (GMT) composite comprising polypropylene or a similar matrix that is blended with continuous or chopped, randomly oriented glass fibers. GMT is produced by third-party material compounders, and sold as standard or custom size flat blanks to be molded. Using this pre-impregnated composite (or pre-preg as it is more commonly called when using its thermoset equivalent), pieces of GMT are heated in an oven, and then laid on a molding tool. The two matched halves of the molding tool are closed under great pressure, forcing the resin and fibers to fill the entire mold cavity. Once the part is cooled, it is removed from the mold with the assistance of an ejecting mechanism.

Generally, the matched molding tools used for GMT forming are machined from high strength steel to endure the continuous application of the high molding pressure without degradation. These molds are often actively heated and cooled to accelerate cycle times and improve the surface finish quality. GMT molding is considered one of the most productive composite manufacturing processes with cycle times ranging between 30 and 90 seconds. Compression molding does require a high capital investment, however, to purchase high capacity presses (2000-3000 tons of pressure) and high-pressure molds, therefore it is only efficient for large production volumes. Lower volumes of smaller parts can be manufactured using aluminum molds on existing presses to save some cost. Other disadvantages of the process are low fiber fractions (20% to 30%) due to viscosity problems, and the ability to only obtain intermediate quality surface finishes.

Injection Molding

Injection molding is the most prevalent method of manufacturing for non-reinforced polymeric parts, and is becoming more commonly used for short-fiber reinforced thermoplastic composites. Using this method, thermoplastic pellets are impregnated with short fibers and extruded into a closed two-part hardened steel tool at injection pressures usually ranging from 15,000 to 30,000 psi. Molds are heated to achieve high flow and then cooled instantly to minimize distortion. Using fluid dynamic analysis, molds can be designed which yield fibers with specific orientations in various locations, but generically injection molded parts are isotropic. The fibers in the final parts typically are no more than 3 millimeters long, and the maximum fiber volume content is about 40%. A slight variation of this method is known as resin transfer molding (RTM). RTM manufacturing utilizes matted fibers that are placed in a mold which is then charged with resin under high pressure. This method has the advantages of being able to manually orient fibers and use longer fiber lengths.

Injection molding is the fastest of the thermoplastic processes, and thus is generally used for large volume applications such as automotive and consumer goods. The cycle times range between 20 and 60 seconds. Injection molding also produces highly repeatable near-net shaped parts. The ability to mold around inserts, holes and core material is another advantage. Finally, injection molding and RTM generally offer the best surface finish of any process.

The process discussed above suffers from real limitations with respect to the size and weight of parts that can be produced by injection molding, because of the size of the required molds and capacity of injection molding machines. Therefore, this method has been reserved for small to medium size production parts. Most problematic from a structural reinforcing point is the limitation regarding the length of reinforcement fiber that can be used in the injection molding process.

Composites and Other Processes

Composites are materials formed from a mixture of two or more components that produce a material with properties or characteristics that are superior to those of the individual materials. Most composites comprise two parts, a matrix component and reinforcement component(s). Matrix components are the materials that bind the composite together and they are usually less stiff than the reinforcement components. These materials are shaped under pressure at elevated temperatures. The matrix encapsulates the reinforcements in place and distributes the load among the reinforcements. Since reinforcements are usually stiffer than the matrix material, they are the primary load-carrying component within the composite. Reinforcements may come in many different forms ranging from fibers, to fabrics, to particles or rods imbedded into the matrix that form the composite.

There are many different types of composites, including plastic composites. Each plastic resin has its own unique properties, which when combined with different reinforcements create composites with different mechanical and physical properties. Plastic composites are classified within two primary categories: thermoset and thermoplastic composites.

Thermoset composites use thermoset resins as the matrix material. After application of heat and pressure, thermoset resins undergo a chemical change, which cross-links the molecular structure of the material. Once cured, a thermoset part cannot be remolded. Thermoset plastics resist higher temperatures and provide greater dimensional stability than most thermoplastics because of the tightly cross-linked structure found in thermoset plastic. Thermoplastic matrix components are not as constrained as thermoset materials and can be recycled and reshaped to create a new part.

Common matrix components for thermoplastic composites include polypropylene (PP), polyethylene (PE), polyetheretherketone (PEEK) and nylon. Thermoplastics that are reinforced with high-strength, high-modulus fibers to form thermoplastic composites provide dramatic increases in strength and stiffness, as well as toughness and dimensional stability.

Molding Methods for Thermoplastic Composites Requiring “Long” Fibers

None of the processes described above are capable of producing a thermoplastic composite reinforced with long fibers (i.e., greater than about 12 millimeters) that remain largely unbroken during the molding process itself; this is especially true for the production of large and more complex parts. Historically, a three-step process was utilized to mold such a part: (1) third party compounding of pre-preg composite formulation; (2) preheating of pre-preg material in oven, and, (3) insertion of molten material in a mold to form a desired part. This process has several disadvantages that limit the industry's versatility for producing more complex, large parts with sufficient structural reinforcement.

One disadvantage is that the sheet-molding process cannot produce a part of varying thickness, or parts requiring “deep draw” of thermoplastic composite material. The thicker the extruded sheet, the more difficult it is to re-melt the sheet uniformly through its thickness to avoid problems associated with the structural formation of the final part. For example, a pallet having feet extruding perpendicularly from the top surface is a deep draw portion of the pallet that cannot be molded using a thicker extruded sheet because the formation of the pallet feet requires a deep draw of material in the “vertical plane” and, as such, will not be uniform over the horizontal plane of the extruded sheet. Other disadvantages associated with the geometric restrictions of an extruded sheet having a uniform thickness are apparent and will be described in more detail below in conjunction with the description of the present invention.

A series of U.S. Pat. Nos. (the Polk patents) 7,208,219, 6,900,547, 6,869,558 and 6,719,551 describe molding systems for producing a thermoplastic resin of thermoplastic composite parts using either a vacuum or compression mold with parts being fed directly to the molds from an extrusion die while the thermoplastic slab still retains the heat used in heating the resins to a fluid state for forming the sheets of material through the extrusion die. These patents describe a thermoplastic molding process and apparatus using a thermoplastic extrusion die having adjustable gates (dynamic dies) for varying the thickness of the extruded material, which material is molded as it is passed from the extrusion die. In addition they describe a continual thermoforming system that is fed slabs of thermoplastic material directly from an extruder forming the slabs of material onto a mold that can be rotated between stations.

The thermoplastic material is extruded through an extrusion die that is adjustable for providing deviations from a constant thickness plastic slab to a variable thickness across the surface of the plastic slab. The variable thickness can be adjusted for any particular molding run or can be continuously varied as desired. This allows for continuous molding or thermoplastic material having different thickness across the extruded slab and through the molded part to control the interim part thickness of the molded part so that the molded part can have thick or thin spots as desired throughout the molded part.

The technology of the aforementioned patents has been extremely useful for the production of large parts and for the production of parts made up of composite materials. In particular, the use of these technologies has allowed a “near net shape” deposition of molten composite material into the lower half of mold sets. Since the filled half of the mold represents a “near net shape” of the final molded part, the final compression molding step with the other half of the matched mold can be accomplished at very low pressures (<2000 psi) and with minimal movement of the molten composite material.

As thermoplastic demands continue to grow there is a growing need to move into even higher strength and stiffness. This has led to the exploration of nano-composites and higher temperature materials. Much higher melt temperatures means that much greater care must be taken to limit the heat history of these materials during processing. The use of systems like the dynamic dies described in U.S. Pat. Nos. 7,208,219, 6,900,547, 6,869,558 and 6,719,551, which because of their volume must maintain the melted composite feed at a high temperature too long, can lead to thermal degradation which increases material waste and lowers overall part quality and surface finish.

There is a need then for a much improved process that can still provide large and complex geometries from long-fiber reinforced plastics and operate in much higher temperature ranges to provide increased strength and stiffness but to do so with much shorter temperature history during processing. The development described herein can provide all of the flexibility and capability for producing large and complex geometries from long-fiber reinforced plastic materials and the use of either thermoplastic or thermoset polymers without the use of the dynamic dies of the prior art previously described.

### SUMMARY OF THE INVENTION

In one embodiment this need is met by a system for forming an article from polymeric material and reinforcing material, the system comprising: a heater operable to pre-heat the polymeric material and reinforcing material; an injection unit barrel coupled to the heater and operable to melt and mix the molten polymeric material with the reinforcing material to form a flow of the resulting composite polymeric material for gravitating downward; a first trolley movable on parallel rails and operable to be moved in space and time in the direction of the parallel rails; a second trolley coupled to and above the first trolley operable to move on parallel tracks in space and time in a direction perpendicular to the parallel rails; a lower mold coupled to the top of the second movable structure and positioned to receive the flow of composite polymeric material gravitating downward; and a press coupled to the upper portion of the mold and capable of receiving the first and second trolleys with the lower portion of the mold, the press operable to press the upper portion of the mold against the predetermined quantity of molten composite polymeric material on the lower portion of the mold to form the article.

The need is also met by a method for forming an article using an upper and lower mold from polymeric material and reinforcing material, comprising the steps of: heating and blending the polymeric material and reinforcing material to form a molten composite material; flowing the molten composite material to gravitate onto said lower mold; moving said lower mold in space and time in both x and y directions which are perpendicular directions while receiving molten composite material to conform to cavity of lower and upper portions of mold, and when mold filling is complete; moving said lower mold under a press containing said upper mold; and pressing upper mold onto lower mold to form said article.

### BRIEF DESCRIPTION OF THE DRAWINGS

Other objects, features, and advantages of the present invention will be apparent from the written description and the drawings in which:

FIG. 1 is an overview of a molding system in accordance with the present invention.

FIG. 2 is an expanded view of the lower mold assembly and feed system of FIG. 1.

FIG. 3 is an alternate expanded view of the lower mold assembly and feed system of FIG. 1.

FIG. 4 is a top view of the lower mold assembly and feed system of FIG. 1.

FIG. 5 is a rear view of the lower mold assembly and feed system of FIG. 1.

FIG. 6 is a stepwise block diagram description of the process for producing composite polymeric parts.

FIG. 7 is a stepwise block diagram description of the process for producing composite polymeric parts using inserts.

FIG. 8 is a perspective top view of a corner of a pallet that can be produced by the molding system of FIG. 1.

FIG. 9 is a perspective bottom view of a platform having hidden ribs that can be produced by the molding system of FIG. 1.

FIG. 10 is a perspective top view of a platform having hidden ribs that can be produced by the molding system of FIG. 1.

### DETAILED DESCRIPTION OF THE INVENTION

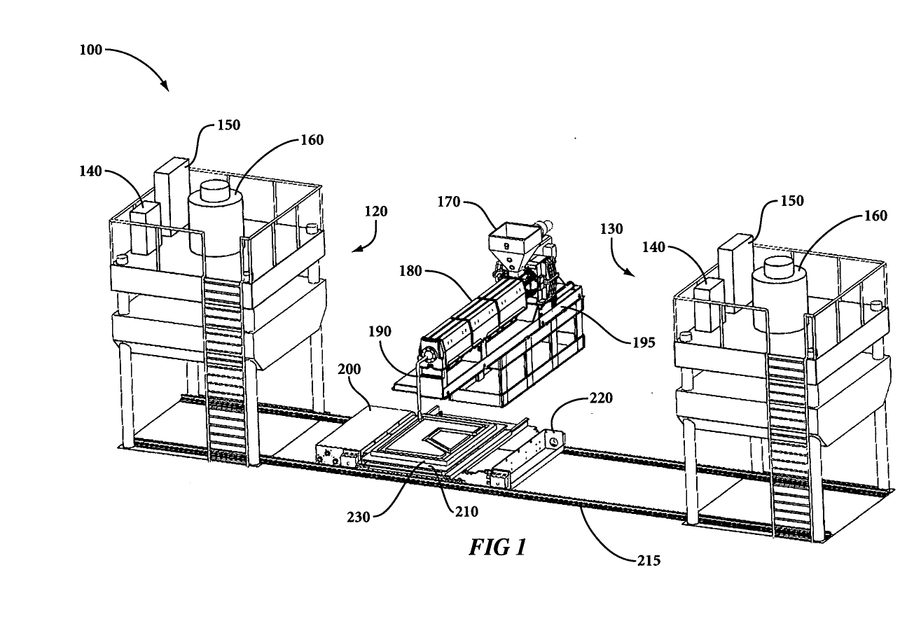

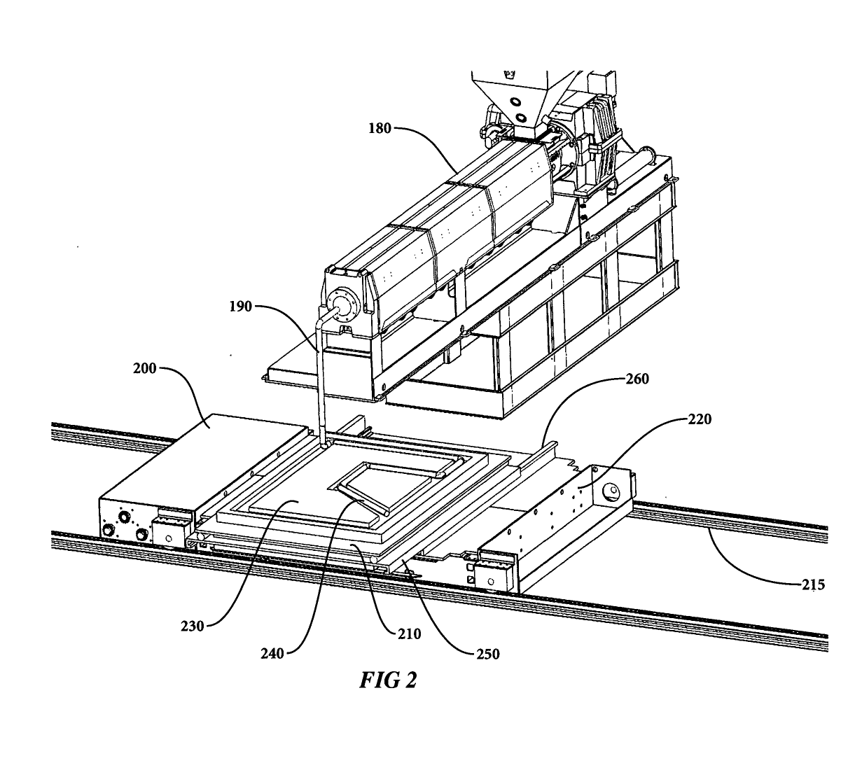

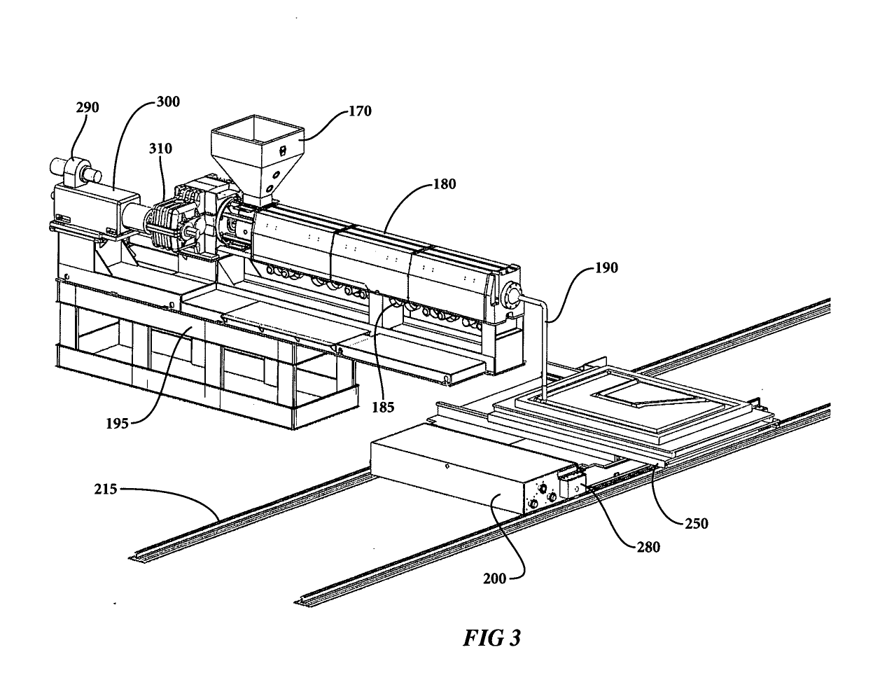

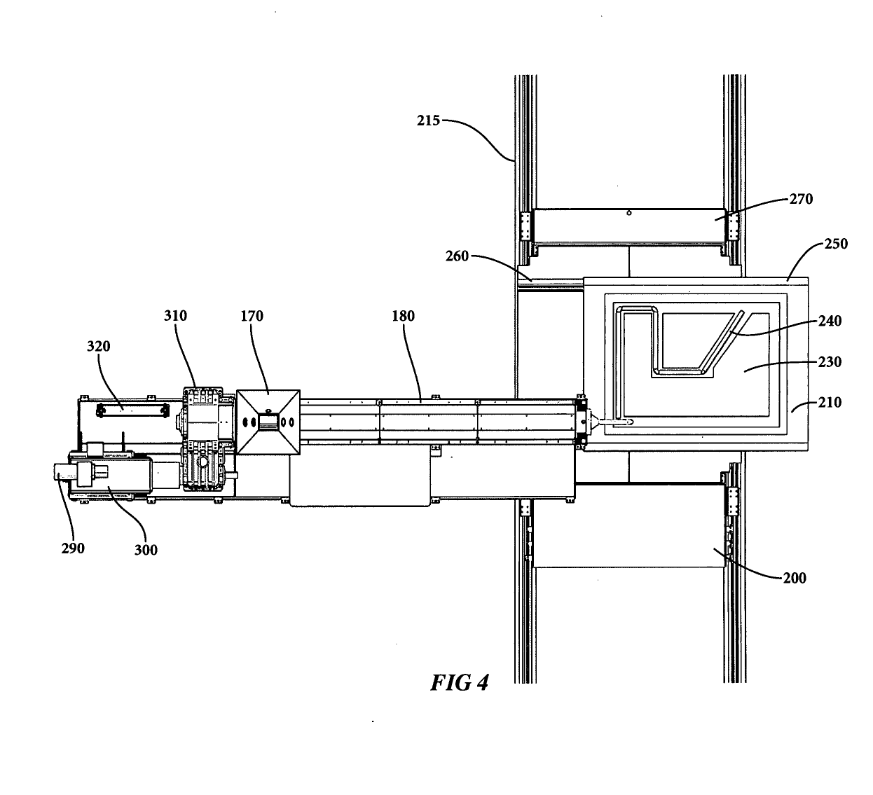

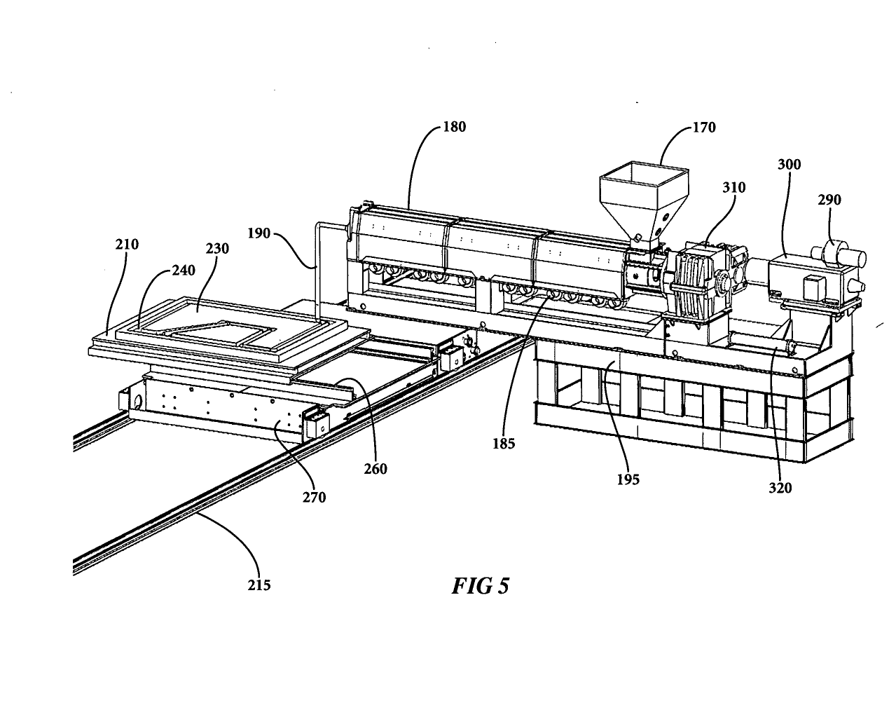

Referring to FIGS. 1-5 of the drawings, an embodiment of the plastic molding device is shown generally as the numeral 100. A mold base 210, is located directly below a deposition tool 190 connected to an injection unit barrel 180 supported by an injection barrel frame 195. Positioned on mold base 210 is a lower compression mold 230 for accepting molten plastic composite material 240 in preparation for molding.

In the embodiment of FIGS. 1-5 a system using two presses, 120 and 130, is shown. Alternate embodiments can operate with one press. Each of the presses contains an upper mold required for compression molding of the parts. Each press has a hydraulic ram 160 for applying compressive force as well as two control cabinets 140, 150. The complete lower mold assembly rides on a first movable structure (the first trolley) that rides on rails 215. The trolley can move back and forth below deposition tool 190 in a direction (the x direction) that is parallel to rails 215. The first trolley is interfaced between a mold carrier device 200 and a wheel block support 220 that provide a drive mechanism for moving the lower trolley.

To achieve control of material deposition in the “y” direction, that is perpendicular to the rails, the system has a second movable structure (the second trolley) with a table guide 250 that rides on y-direction tracks 260 above the first trolley. The combination of being able to control both x and y direction movement by use of one trolley riding on the other gives control of the x-y plane. When this is combined with the ability to control the volumetric flow of molten composite material 240 emanating from deposition tool 190, this gives in effect 3-axis control and the capability to create “near net shape” parts on the lower mold before the upper mold is applied for compression. While the prior art dynamic die systems could do this they did it with the much longer high temperature hold-up times associated with the dynamic die volumes. A preferred embodiment of the deposition tool is a simple injection nozzle, which may be a simple pipe and would have significantly less hold-up time than a dynamic die. And, as mentioned before, the markets move toward higher temperature plastics has created a need for shorter hold up times to reduce waste, part quality, and surface finish.

Turning now to the composite material feed system; FIGS. 1-5 show a possible embodiment of a feed system. A material feed hopper 170 accepts polymeric resin or composite material into an auger or screw section where heaters are heating the polymeric material to a molten state while the auger or screw is feeding it along the length of an injection barrel 180 that can be an extruder or an injection head. An injection head would be a preferred embodiment for high temperature composite systems. A screw motor 300 with a cooling fan 290 drives a hydraulic injection unit 310, with a cooling fan 290. Heaters 185 along the injection barrel maintain temperature control. At the exit of the injection barrel is shown in one embodiment as a deposition tool 190 for feeding the molten composite material 240 precisely onto the lower mold 230. It should be noted that the deposition tool in some embodiments could be as simple as a straight pipe acting as an injection nozzle but could also be a sheet die.

The combination of x-y control of the mold base and control of the volumetric flow rate of the molten material 240 allows precise deposition of the molten composite material into the desired location in the lower mold 230 so that a “near net shape” of the molded part is created, including sufficient molten material 240 deposited in locations with deeper cavities in the lower mold. Upon completion of the “near net shape” molten deposition of the composite material 240, the filled half of the matched mold is mechanically transferred by means of the first trolley system along rails 215 to compression press 120 or 130 for final consolidation of the molded part. Since the filled half of the mold represents a “near net shape” of the final molded part, the final compression molding step with the other half of the matched mold can be accomplished at very low pressures (<2000 psi) and with minimal movement of the molten composite mixture.

The extrusion-molding process includes a computer-controlled extrusion system that integrates and automates material blending or compounding of the matrix and reinforcement components to dispense a profiled quantity of molten composite material that gravitates into the lower half of a matched-mold, the movement of which is controlled while receiving the material, and a compression molding station for receiving the lower half of the mold for pressing the upper half of the mold against the lower half to form the desired structure or part. The lower half of the matched-mold discretely moves in space and time at varying speeds and in a back and fourth movement and in both the x and y directions to enable the deposit of material precisely and more thickly at slow speed and more thinly at faster speeds. The polymeric apparatus described above is one embodiment for practicing the extrusion-molding process. Unprocessed resin (which may be any form of regrind or pleated thermoplastic or, optionally, a thermoset epoxy) is the matrix component fed into a feeder or hopper of the injection head, along with reinforcement fibers greater than about 12 millimeters in length. The composite material 240 may be blended and/or compounded by the injection barrel 180, and “intelligently” deposited onto the lower mold half 230 by controlling the output of the injection barrel 190 and the movement of the lower mold half 230 in both the x and y directions relative to the position of deposition tool 190. The lower section of the matched-mold receives precise amounts of extruded composite material, and is then moved into the compression molding station.

The software and computer controllers needed to carry out this computer control encompass many known in the art. Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry out the invention may be a stand-alone application, network based, or wired or wireless Internet based to allow easy, remote access. The application may be run on a personal computer, a data input system, a PDA, cell phone or any computing mechanism.

The firsts trolley may further include wheels (not shown) that provide for translation along rail 215. The rail 215 enables the first trolley to roll beneath the deposition tool 190 and into either press 120 or 130. The presses operate to press an upper mold into the lower mold. Even though the principles of the present invention provide for reduced force for the molding process than conventional thermoplastic molding processes due to the composite material 240 layer being directly deposited from deposition tool 190 to the lower mold, the force applied by the press is still sufficient to damage the wheels if left in contact with the rail. Therefore, the wheels may be selectively engaged and disengaged with an upper surface of the press. In one embodiment, the first trolley is raised by inflatable tubes (not shown) so that when the tubes are inflated, the wheels engage the rails 215 so that the trolley is movable from under deposition tool 190 to the press. When the tubes are deflated, the wheels are disengaged so that the body of the trolley is seated on the upper surface of a base of the press. It should be understood that other actuated structural components might be utilized to engage and disengage the wheels from supporting the trolley.

The computer based controller (not shown) is electrically coupled to the various components that form the molding system or could operate in a wireless manner. The controller is a processor-based unit that operates to orchestrate the forming of the structural parts. In part, the controller operates to control the composite material being deposited on the lower mold by controlling temperature of the composite material, volumetric flow rate of the extruded composite material, and the positioning and rate of movement of the lower mold via the two trolley x-y system to receive the extruded composite material. The controller is further operable to control the heaters that heat the polymeric materials. The controller may control the rate of the screw to maintain a substantially constant flow of composite material 240 through the injection head and into deposition tool 190. Alternatively, the controller may alter the rate of the screw to alter the volumetric flow rate of the composite material 240 from the injection head. The controller may further control heaters in the injection head. Based on the structural part being formed, a predetermined set of parameters may be established for the deposition tool 190 to apply the extruded composite material 240 to the lower mold. The parameters may also define how the movement of the two trolley system is positionally synchronized with the volumetric flow rate of the composite material in accordance with the cavities on the lower mold that the define the structural part being produced.

Upon completion of the extruded composite material 240 being applied to the lower mold, the controller drives the first trolley into either press. The controller then signals a mechanism (not shown) to disengage the wheels from the track 215 as described above so that the press 120 or 130 can force the upper mold against the lower mold without damaging the wheels.

Note that the extrusion-molding system of the drawings is configured to support two presses 120 and 130 that are operable to receive the trolley assembly that supports the lower mold to form the structural part. It should be understood that two two-trolley systems might be supported by the tracks or rails 215 so as to provide for forming multiple structural components by a single injection barrel and deposition tool. Note also that while wheels and rails may be utilized to provide movement for the trolley mechanisms as described in one embodiment, it should be understood that other movement mechanisms may be utilized to control movement for the two trolley combination. For example, a conveyer, suspension, or track drive system may be utilized to control movement for the trolley. The invention described herein anticipates any of those embodiments.

The controller may also be configured to support multiple structural parts so that the extrusion-molding system may simultaneously form the different structural parts via the different presses 120 and 130. Because the controller is capable of storing parameters operable to form multiple structural parts, the controller may simply alter control of the injection unit and trolleys by utilizing the parameters in a general software program, thereby providing for the formation of two different structural parts using a single injection unit. It should be understood that additional presses and trolleys might be utilized to substantially simultaneously produce more structural parts via a single injection head.

By providing for control of the dual trolley system and reinforced composite material 240 being applied to the lower mold in precise “near net shapes”, any pattern may be formed on the lower mold, from a thick continuous layer to a thin outline of a circle or ellipse, any two-dimensional shape that can be described by discrete mathematics can be traced with material. Additionally, because control of the volume of composite material deposited on a given area exists, three-dimensional patterns may be created to provide for structural components with deep draft and/or hidden ribs, for example, to be produced. Once the structural part is cooled, ejectors may be used to push the consolidated material off of the mold. The principles of the present invention may be designed so that two or more unique parts may be produced simultaneously, thereby maximizing production efficiency by using a virtually continuous stream of composite material.

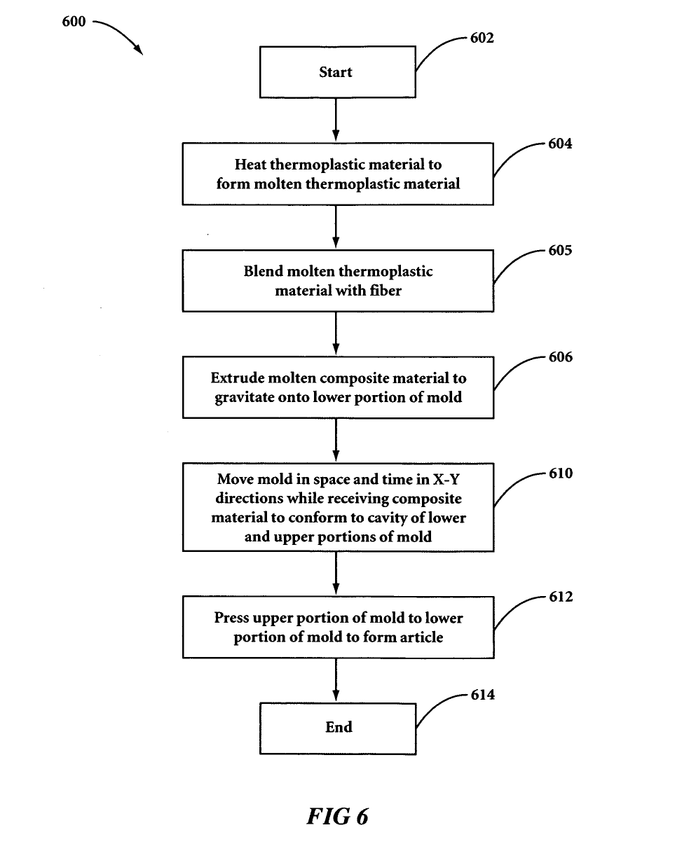

FIG. 6 is a flow diagram describing the extrusion-molding process 600 that may be utilized to form articles or structural parts by using either two- or three-axis control for depositing the composite material 240 onto the lower mold 230. The extrusion-molding process starts at step 602. At step 604, the polymeric material is heated to form molten polymeric material and blended with the fiber at step 605 to form a composite material. At step 606, the molten composite material 240 is delivered through injection barrel 180 and then extruded through deposition tool 190 to gravitate onto lower mold 230. In step 610 he lower mold 230 may be moved in space and time in the x-y directions while receiving the composite material 240 to conform the amount of composite material required in the cavity defined by the lower and upper molds. At step 612, the upper mold is pressed to the lower mold 230 to press the composite material 240 into the lower and upper molds and form the article. The process ends at step 614. In this process the fibers may be long strands of fiber formed of glass or other stiffening material utilized to form large structural parts. For example, fiber lengths of 12 millimeters up to 100 millimeters or more in length may be utilized in forming the structural parts.

Insertion Techniques

In addition to forming structural parts using composite material having blended fibers to provide strength in forming large parts, some structural parts further are structurally improved by having other components, such as attachments, fasteners, and/or stiffeners, inserted or embedded in certain regions. For example, structural parts that are to provide interconnectivity may utilize metallic parts extending from the composite material to provide strong and reliable interconnections.

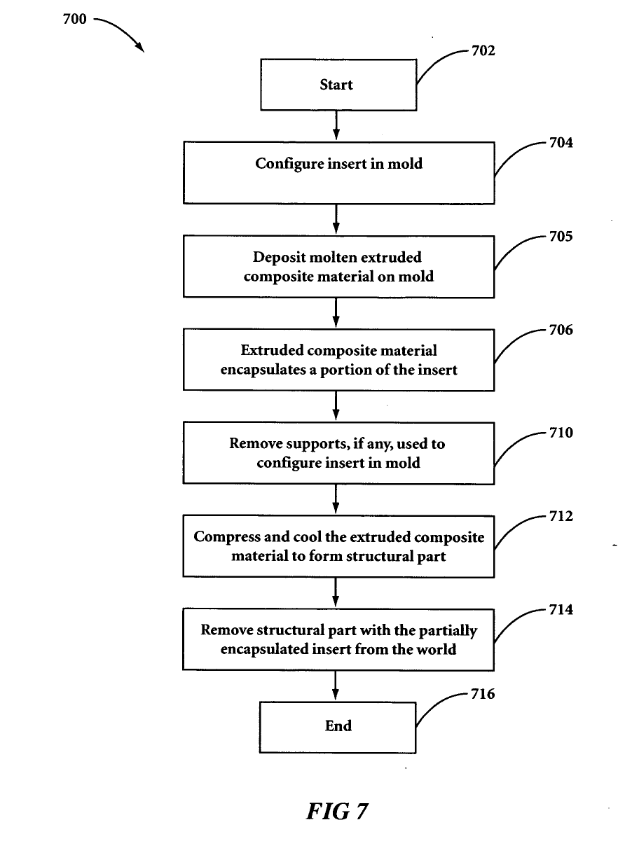

FIG. 7 is a flow diagram 700 describing the operations for embedding or inserting an insert, such as a fastener, support, or other element, into a structural part utilizing the extrusion-molding system of FIGS. 1-5. The insertion process starts at step 702. At step 704, the insert is configured in either the lower or upper mold. At step 705, the molten extruded composite material 240 is deposited on the lower mold 230. The extruded composite material 240 is formed about at least a portion of the insert at step 706 to secure the insert into the structural part being formed. In one embodiment, the insert is encapsulated or completely embedded in the extruded composite material. Alternatively, only a portion of the insert is embedded in the extruded composite material so that a portion extends from the structural part.

At step 710, if any supports are used to configure the insert in the lower or upper mold, then the supports are removed. The supports, which may be actuator controlled, simple mechanical pins, or other mechanism capable of supporting the insert during deposition of the extruded composite material 240 onto the lower mold, are removed before the extruded composite material layer is hardened at step 712. The extruded composite material layer may be hardened by natural or forced cooling during pressing, vacuuming, or other operation to form the structural part. By removing the supports prior to the extruded composite material layer being hardened, gaps produced by the supports may be filled in, thereby leaving no trace of the supports or weak spots in the structural part. At step 714, the structural part with the insert at least partially embedded therein is removed from the mold. The insertion process ends at step 716.

In another embodiment of the invention, an insert is encapsulated by a process of the claimed invention. In a manner analogous to the process described in FIG. 7, an insert, such as a fastener, support, or other element, may be encapsulated with extruded polymeric material utilizing the claimed extrusion-molding system. In other embodiments of the invention, multiple layers of material of varying thickness may be deposited one on top of the other utilizing the claimed extrusion-molding system. Specifically, a first layer of polymeric material is extruded into a lower mold, following which a second layer of the same or different polymeric material is layered on top of the first layer. In certain embodiments of the invention, an insert may be placed on top of the first extruded layer prior to or instead of layering the first layer with a second extruded layer. This form of “layering” can facilitate the formation of a structure having multiple layers of polymeric material, of the same or different composition, and layers of different inserted materials.

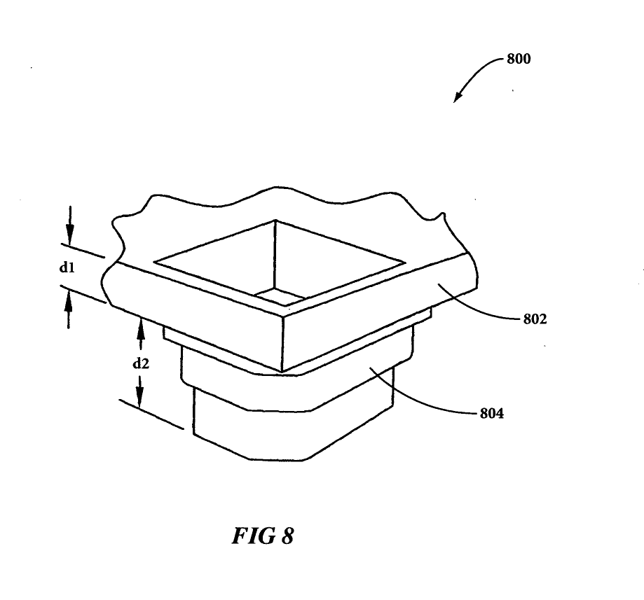

FIG. 8 is a perspective top view of a corner of a pallet 800 produced by the extrusion-molding system of FIGS. 1-5. As shown, the draft or depth d1 of the base 802 of pallet 800 is shallower than the depth d2 of a foot 804 of pallet 800. By controlling the deposition of the extruded composite material 240 onto the lower mold 230 utilizing the principles of the present invention, large structural parts having features, such as the foot 804, having a deeper draft d2 in specific regions of the structural parts may be formed using stiffener material (e.g., long-strand fibers).

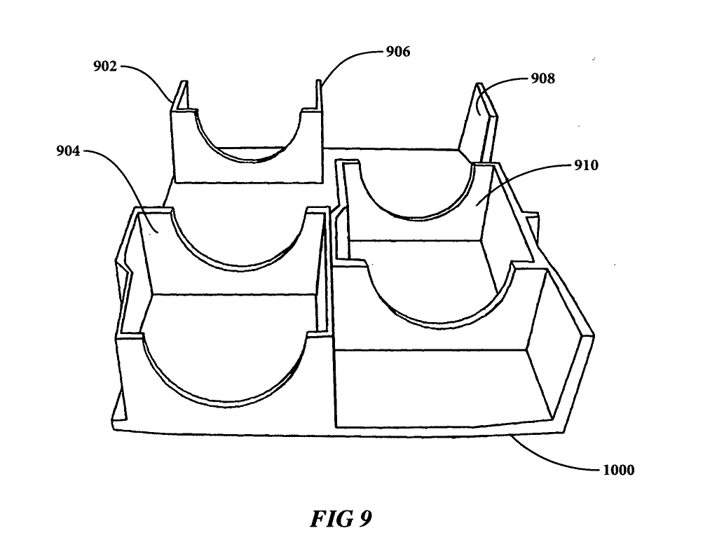

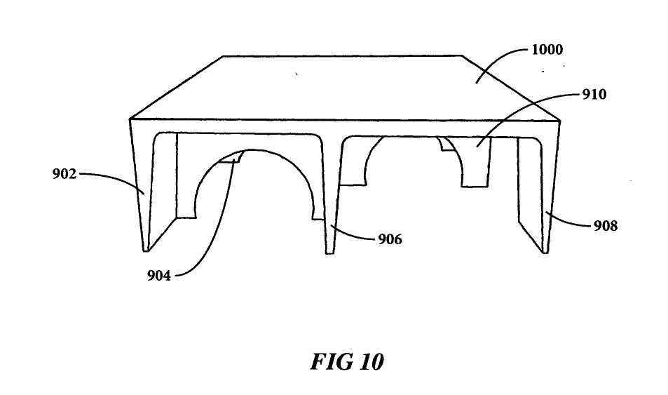

FIGS. 9 and 10 are a perspective bottom and top views, respectively; of a platform 1000 having hidden ribs 902,904,906,908,910. As shown, the hidden ribs are variable in height, but have a definite volume over one or more zones. Therefore, by depositing more extruded composite material 240 over the zones having the hidden ribs and less extruded composite material 240 over the zones without the hidden ribs the platform can be formed as a single molded composite structure using the extrusion-molding system 100 and the resulting platform has fewer weaknesses in the structure compared to a platform that is formed of multiple parts.

Value-Added Benefits of the Extrusion-Molding Process

With this extrusion-molding system, large long-fiber reinforced plastic parts utilizing higher temperature polymerics may be produced in-line and at very low processing costs. The use of the x-y control of the lower mold on the two trolley system result in the reduced hold up times inherent in the injection nozzle allow significantly reduced time-temperature history for the molten material when compared to the prior art. Features of the extrusion system provide for a reinforced plastic components production line that offers (i) materials flexibility, (ii) deposition process, (iii) low-pressures, and (iv) machine efficiency. Materials flexibility provides for savings in both material and machine costs from in-line compounding, and further provides for material property flexibility. The deposition process adds value in the material deposition process, which allows for more complicated shapes (e.g., large draft and ribs), better material flow, and ease of inclusion of large inserts in the mold. The low-pressures is directed to reduced molding pressures, which lessen the wear on both the molds and the machines, and locks very little stress into the structural parts. The machine efficiency provides for the ability to use two or more completely different molds at once to improve the efficiency of the extrusion system, thereby reducing the required number of machines to run a production operation. Additionally, the material delivery system according to the principles of the present invention may be integrated with many existing machines and offers configuration flexibility with respect to multiple molds and presses.

Materials Flexibility

The extrusion-molding process allows custom composite blends to be compounded using several different types of resin and fiber. The extrusion system may produce parts with several resins as described above. With traditional compression molding, pre-manufactured thermoplastic sheets, commonly known as blanks that combine a resin with fibers and desired additives are purchased from a thermoplastic sheet producer. These blanks, however, are costly because they have passed through several middle-men and are usually only sold in pre-determined mixtures. By utilizing the extrusion-molding process according to the principles of the present invention, these costs may be reduced by the in-line compounding process utilizing the raw materials to produce the structural parts without having to purchase the pre-manufactured sheets. Labor and machine costs are also dramatically reduced because the extrusion-molding system does not require ovens to pre-heat the material and operators to move the heated sheets to the mold. Since the operator controls the compounding ratios as desired, nearly infinite flexibility is added to the process, including the ability to alter properties while molding or to create a gradual change in color, for example. Also, unlike sheet molding, the extrusion-molding system does not require the material to have a melt-strength, giving the system added flexibility. In one embodiment, the extrusion-molding system may utilize thermoset resins to produce the structural parts. The extrusion-molding system may also use a variety of fiber materials, including carbon, glass and other fibers as described above, for reinforcement with achievable fiber volume fractions of over 50 percent and fiber lengths of 12 millimeters to 100 millimeters or longer with 85 percent or higher of the fiber length being maintained from raw material to finished part.

Deposition Process

The extrusion system, according to the principles of the present invention, allows for variable composite material lay-down; in regions of the mold where more material is to be utilized for deep draft or hidden ribs, for example, thereby minimizing force utilized during molding and pressing. The variable composite material lay-down results in more accuracy, fuller molds, and fewer “short-shots” as understood in the art than with typical compression molding processes. Variable lay-down also allows for large features to be molded on both sides of the structural part, as well as the placement of inserts or cores into the structural part. Lastly, since the material has a relatively very low viscosity as it is being deposited in a molten state onto the mold (as opposed to being pre-compounded into a sheet and then pressed into a mold), fibers are able to easily enter ribs and cover large dimensional areas without getting trapped or becoming undesirably oriented.

Low-Pressures

The polymeric composite material being deposited during the extrusion-molding process is much more fluid than that from a heated pre-compounded sheet, thus allowing the polymeric composite material to flow much easier into the mold. The fluidity of the composite material being deposited onto the mold results in significantly reduced molding pressure requirements over most other molding processes. Presses for this process generally operate in the range of 100 pounds per square inch, compared with 1,000 pounds per square inch of pressure used for compression molding. This lower pressure translates to less wear, thereby reducing maintenance on both the molds and the press. Because of the lower pressures, instead of needing a steel tool that could cost over $200,000, an aluminum mold, capable of 300,000 cycles, and may be manufactured for as little as $40,000. Less expensive tooling also means more flexibility for future design changes. Since the polymeric resin is relocated and formed on the face of the mold under lower pressures, less stress is locked into the material, thereby leading to better dimensional tolerance and less warpage.

Machine Efficiency

Because the extrusion-molding process may use two or more molds running at the same time, there is a reduction in the average cycle time per part, thus increasing productivity as the first mold set may be cooled and removed while a second mold is filled and compressed. Also, the extrusion-molding system utilizes minimal redundant components. In one embodiment, the extrusion system utilizes a separate press for each mold, but other equipment may be consolidated and shared between the mold sets and may be easily modified in software to accommodate other molds. The extrusion and delivery system 100 further may be integrated into current manufacturing facilities and existing compression molds and presses may be combined.

Advantageously, the present invention permits molding of articles having solid raised three-dimensional features. A non-limiting list of these raised features are blind ribs, posts, mounting posts, and tabs.

The articles may optionally have internal reinforcing inserts to provide additional stability and strength. Examples of reinforcing inserts are tubes, rods, and mesh, although any kind of internal support structure can be used to provide the reinforcement. The reinforcing inserts can have any type of geometry or structure. For example, the cross-sectional appearance of the reinforcing inserts can be circular, hemispherical, star-shaped, or square, without restriction. The reinforcing inserts can also be formed from any kind of material, such as carbon, metals, synthetics, plastics, or organic substances such as wood.

The invention can be used to obtain large items, such as items longer than 0.5 feet in at least one of the z-, y-, and z-planes. In particular embodiments, large articles having dimensions longer than 1 foot, 2 feet, and 3 feet can be obtained. The large articles can also be heavy, and can have weight greater than 10 lbs. In particular embodiments, articles with weights greater than 20 lbs or 25 lbs can be prepared.

The molding process conducted in accordance with the present invention is conducted at substantially lower compression pressures than those typically used in the industry. Advantageously, these low pressures permit the use of non-metallic molds, such as wooden molds, which would generally not be able to withstand the high pressures used in the industry.

Any type of fibrous material can be used in the present invention. For example, the fibrous material can be glass fibers, fiberglass, carbon fibers, synthetic fibers, metal fibers, natural fibers, cellulose, or wood. In addition novel nano-particle additives can be used.

Any kind of polymeric resin can be used to prepare articles in accordance with the present invention. Examples of suitable polymeric resins, some thermoplastic and some thermoset, are polyolefins, polyhaloolefins, polyaromatics, poly(alkenylaromatics), polystyrene, acrylonitrile/butadiene /styrene resins, polyamides, nylon, poly(carboxylic acids), polyamines, polyethers, polyacetals, polysulfones, poly(organicsulfides), poly(organicoxides), polyesters, polycarbonates, polyimides, polyurethanes, polyetheretherketone resins, styrene/maleic anhydride resins, allyl resins, epoxies, melamine formaldehyde, phenol-formaldehyde, silicones, and mixtures thereof.

The polymeric resin can be a single polymer, or a mixture of two or more polymers. In particular embodiments, the polymeric resin can comprise a homopolymer, copolymer, random copolymer, alternating copolymer, block copolymer, graft copolymer, liquid crystal polymer, or a mixture of these polymers.

The polymeric resin can be a virgin resin, a recycled resin, or a mixture of a virgin resin and a recycled resin in any proportion. The polymeric resin may optionally comprise a coupling agent which enhances bonding of the fibrous material to the resin.

Articles such as pallets, beams, doors, radomes, construction products such as wall panels and modular components, pipes, pillars, and piling can be successfully prepared according to the claimed invention.

The foregoing description is of a preferred embodiment for implementing the invention, and the scope of the invention should not be limited by this description. The scope of the present invention is instead defined by the following claims.

1. A system for forming an article from polymeric material and reinforcing material, said system comprising:
a. a heater operable to pre-heat said polymeric material and reinforcing material;
b. an injection unit barrel coupled to the heater and operable to melt and mix the molten polymeric material with the reinforcing material to form a flow of the resulting composite polymeric material for gravitating downward;
c. a first trolley movable on parallel rails and operable to be moved in space and time in the direction of the parallel rails;
d. a second trolley coupled to and above the first trolley operable to move on parallel tracks in space and time in a direction perpendicular to said parallel rails;
e. a lower mold coupled to the top of said second movable structure and positioned to receive said flow of composite polymeric material gravitating downward; and
f. a press coupled to the upper portion of the mold and capable of receiving said first and second trolleys with the lower portion of the mold, said press operable to press the upper portion of the mold against the predetermined quantity of molten composite polymeric material on the lower portion of the mold to form the article.

2. The system of claim 1, further comprising a deposition tool, said injection unit barrel and said deposition tool operable to control the flow of composite polymeric material in a varied amount of molten composite polymeric material being delivered to the lower portion of the mold.

3. The system of claim 1, wherein said deposition tool is a sheet die, said injection unit barrel and said sheet die operable to control the flow of composite polymeric material in a varied amount of molten composite polymeric material being delivered to the lower portion of the mold.

4. The system of claim 1, wherein said deposition tool is an injection nozzle, said injection unit barrel and said injection nozzle operable to control the flow of composite polymeric material in a varied amount of molten composite polymeric material being delivered to the lower portion of the mold.

5. The system of claim 1, wherein said injection unit barrel is an injection head.

6. The system of claim 5, wherein said injection head includes an screw having a thread spacing large enough to blend the molten polymeric material with the fibers being between approximately 12 millimeters and approximately 100 millimeters in length.

7. The system of claim 1, wherein said injection unit barrel is an extruder.

8. The system according to claim 1, wherein the blended molten composite polymeric material has a concentration of fiber of at least approximately ten percent by weight.

9. The system according to claim 1, further comprising a controller coupled to said first trolley and operable to move said first trolley to position the lower mold to form a predetermined quantity of molten composite material of varying thickness on the mold.

10. The according to claim 1, wherein said first trolley includes wheels operable to move the first trolley.

11. The system according to claim 1, further comprising a controller coupled to said injection unit barrel and operable to vary the volumetric flow rate of the molten polymeric composite material and gravitate the molten composite polymeric material onto the lower mold.

12. The system of claim 11, wherein said controller moves said first trolley directly below said injection unit barrel for gravitating the extruded composite polymeric material onto the lower mold.

13. The system of claim 1, wherein said polymeric material is a thermoplastic plastic.

14. The system of claim 1, wherein said polymeric material is a thermoset plastic.

15. A method for forming an article using an upper and lower mold from polymeric material and reinforcing material, comprising the steps of:
a. heating and blending the polymeric material and reinforcing material to form a molten composite material;
b. flowing the molten composite material to gravitate onto said lower mold;
c. moving said lower mold in space and time in both x and y directions which are perpendicular directions while receiving molten composite material to conform to cavity of lower and upper portions of mold, and when mold filling is complete;
d. moving said lower mold under a press containing said upper mold; and
e. pressing upper mold onto lower mold to form said article.

16. The method of claim 15, wherein said polymeric material is a thermoplastic plastic.

17. The method of claim 15, wherein said polymeric material is a thermoset plastic.

18. The method according to claim 15, further comprising controlling the flow of composite material to vary the quantity of molten composite material being delivered to the lower portion of the mold.

19. The method according to claim 15, wherein said blending includes blending the molten polymeric material with the fibers being between approximately at least 12 millimeters and approximately 100 millimeters in length.

20. The method according to claim 15, wherein said blending forms a molten composite polymeric material having a concentration of fiber of approximately at least ten percent by weight.

21. The method according to claim 15, further comprising controlling said flowing to vary the volumetric flow rate of the molten composite polymeric material being gravitated onto the lower mold.

22. The method according to claim 15, wherein the molten composite polymeric material is extruded on to an insert contained within the lower mold.

23. The method according to claim 22, wherein the insert is partially embedded within the molten composite polymeric material.

24. The method according to claim 15, wherein a first layer of thermoplastic composite material is extruded into the lower portion of the mold.

25. The method according to claim 24, wherein a second layer of thermoplastic material is layered on top of the first layer.

26. The method according to claim 24, wherein an insert is placed on the first layer.

27. The method according to claim 26, wherein said insert is partially embedded within the first layer.

28. The method according to claim 26, wherein a second layer of thermoplastic material is layered on top of the insert.
